(19) United States
(12) Patent Application Publication
(10) Pub. No.: US 2015/0302440 A1
(43) Pub. Date: Oct. 22, 2015

(54) CLOUD COMPUTING SOLUTION GENERATION SYSTEMS AND METHODS

(71) Applicant: XOcur, Inc., San Ramon, CA (US)

(72) Inventors: Jason Peter Monden, Trophy Club, TX (US); Daniel David Karmazyn, Boca Raton, FL (US); Perron Richard Sutton, North Richland Hills, TX (US); James Clifton Dougharty, Irving, TX (US)

(21) Appl. No.: 14/687,681

(22) Filed: Apr. 15, 2015

Related U.S. Application Data
(60) Provisional application No. 61/980,917, filed on Apr. 17, 2014.

(51) Int. Cl. G06Q 30/02; H04L 12/24

(52) U.S. Cl. CPC G06Q 30/0206; H04L 41/0826

(57) ABSTRACT

There is disclosed a cloud solutions generator including a back-end processor running asynchronously from the front-end processor. In an embodiment, pricing and services are retrieved from a service provider and normalized into a normalized provider metrics for comparing multiple service providers. One or more benchmarking tests characterize the performance of at least one service provider, storing benchmarking metrics as a result. A user enters business-level user requirements for running a user application having a user application performance and specifying a user cloud configuration of the cloud resources. Business-level user requirements are normalized into normalized user requirements for mapping the normalized provider metrics to the business-level user requirements. A solutions calculator scales the normalized provider metrics by the benchmarking metrics to calculate a potential configuration performance. The solutions calculator stores a finite solution set having the best potential configuration performance and price. Other embodiments are disclosed.

### CROSS-REFERENCE TO RELATED APPLICATIONS

The present application claims priority to U.S. Provisional Application No. 61/980,917 filed on Apr. 17, 2014 and entitled CLOUD COMPUTING SOLUTION GENERATION SYSTEMS AND METHODS, the entire contents of Application 61/980,917 being expressly incorporated by reference herein.

### BACKGROUND

Increasingly, businesses and enterprises are migrating away from privately-owned servers and storage to the Cloud for accessing IT resources via the Internet, thereby reducing capital costs and accelerating start-up time for running a user application. Each cloud service provider (“service provider” or “SP”) offers a different user interface (UI) for provisioning a user cloud configuration of cloud resources for running the user application. The services offering and provider pricing differ as well, each service provider often using different metrics for specifying resources for compute, storage, and memory, for example.

Analyzing the price and performance of a configuration of cloud computing resources may be performed manually with the aid of spreadsheets. However, with potentially millions of combinations of input configurations possible across numerous service providers, the time and labor required to choose an SP may be impractically high, and potentially inaccurate. Price and performance analysis may also be performed using IT consulting services. Unfortunately, IT services can be very expensive, even prohibitive for a start-up enterprise having a small budget.

Alternatively, price calculators, such as those provided online by service providers, allow a user to select discrete values and descriptors from dozens of pull-down menus. However, the result is an estimated price that does not consider actual or aggregate performance of the user application in a ‘real world’ scenario. Additionally, many of the descriptors are cryptic, or ‘provider-centric’, for example, for specifying an instance type or allocating CPU. Another resource for determining which service provider has the best price-performance offering is word of mouth. However, given the fast changing SP landscape and the variability in user needs and discernment, word of mouth alone is insufficient for deciding which SP platform to use. Lastly, each service provider will have unique performance characteristics, some of which can not be directly provisioned, such as the consistency of read/write time in a storage device, or such as actual platform up-time (availability).

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is disclosed a cloud solutions generator for optimizing pricing and performance in a configuration of cloud resources and which may comprise a front-end processor having a user interface and a back-end processor running asynchronously from the front-end processor. Provider pricing and a services offering are retrieved by the back-end processor from at least one service provider and normalized into a normalized provider metrics for comparing multiple service providers and for describing at least one of the type, amount, price and quality of the cloud resources. One or more benchmarking test cases periodically characterize a performance of the services offering of the at least one service provider. The back-end processor stores benchmarking metrics resulting from the executed one or more benchmarking test cases. A user interface receives, from a user, business-level user requirements for running a user application having a user application performance. The business-level user requirements include specifying a user cloud configuration of the cloud resources provisionable from the at least one service provider. The front-end processor normalizes the business-level user requirements into normalized user requirements for mapping the normalized provider metrics to the business-level user requirements. The cloud resources comprise at least one of compute, storage, and memory resources. A solutions calculator connected to the back-end processor scales the normalized provider metrics by the benchmarking metrics to calculate a potential configuration performance for each of at least one potential user configurations of cloud resources specifiable in the business-level user requirements and provisionable by the at least one service provider. The solutions calculator stories a finite solution set for the at least one service provider. The finite solution set comprises at least one service provider having the best potential configuration performance and price for at least one potential user configuration. An optimizer receives the normalized user requirements and selects the at least one potential user configuration in the finite solution set whose potential configuration performance best matches the user application performance. The optimizer stores the selected at least one potential user configuration as an optimized solution for recommending to the user.

In another embodiment, there is disclosed a method for generating a cloud solution optimizing the pricing and performance in a configuration of cloud resources and which may comprise interfacing with a user via a user interface and retrieving a provider pricing and a services offering from at least one cloud service provider. The method may further comprise normalizing the provider pricing and the services offering into a normalized provider metrics for directly comparing multiple cloud service providers. The method may further comprise the normalized provider metrics describing at least one of the type, amount, price and quality of the cloud resources. The method may further comprise benchmarking the at least one cloud service provider for periodically characterizing a performance of the services offering, and storing a benchmarking metrics resulting from the executed one or more benchmarking test cases. The method may further comprise inputting business-level user requirements from the user interface for running a user application having a user application performance. The method may further comprise the business-level user requirements specifying a user cloud configuration of the cloud resources directly provisionable from the at least one cloud service provider, where the cloud resources comprise at least one of compute, storage, and memory resources. The method may further comprise normalizing the business-level user requirements into normalized user requirements for mapping the normalized provider metrics to the business-level user requirements. The method may further comprise scaling the normalized provider metrics by the benchmarking metrics to calculate a potential configuration performance for at least one potential user configuration of cloud resources specifiable in the business-level user requirements and provisionable by the at least one service provider. The method may further comprise storing a finite solution set for the at least one service provider, the finite solution set comprising the at least one service provider having the best potential configuration performance and price for the at least one potential user configuration. The method may further comprise receiving by an optimizer the normalized user requirements and selecting the at least one potential user configuration in the finite solution set whose potential configuration performance best matches the user application performance. The method may further comprise storing the selected at least one potential user configuration as an optimized solution for recommending to the user.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates a system architecture for a cloud solutions generator, in accordance with an embodiment of the present disclosure.

FIG. 2 illustrates a flowchart for performance benchmarking for a cloud solutions generator, in accordance with an embodiment of the present disclosure.

FIG. 3 illustrates a hierarchy of cloud solutions and user inputs for a cloud solutions generator, in accordance with an embodiment of the present disclosure.

FIG. 4 illustrates a hierarchy of business-level user inputs for a cloud solutions generator, in accordance with an embodiment of the present disclosure.

FIG. 5 illustrates a block diagram for user inputs for abstracting data center provisioning for a cloud solutions generator, in accordance with an embodiment of the present disclosure.

FIG. 6 illustrates a flowchart for optimizing compute, memory, and storage resources for a cloud solutions generator, in accordance with an embodiment of the present disclosure.

FIG. 7 illustrates a flowchart for a monitoring service for a cloud solutions generator, in accordance with an embodiment of the present disclosure.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

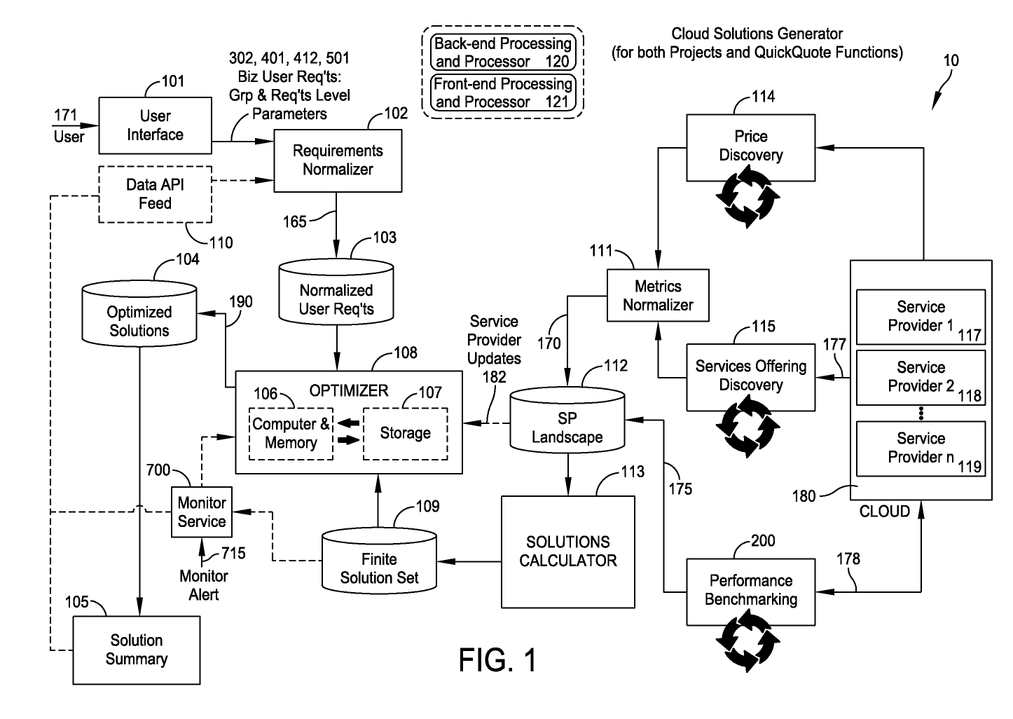

In an embodiment, referring to FIG. 1, the front end of a system architecture for a cloud solutions generator (“solutions generator”) 10 may include a user 171 accessing user interface 101 for inputting business-level user requirements (302, 401, 412, 501) into requirements normalizer 102. Optionally, a data API feed 110 may be used to enter user requirements and receive optimized solutions 104 through solution summary 105, the output of solutions generator 10. Front-end processor 121 may operate elements of the front end as indicated in FIG. 1, including user interface 101, and may direct requirements normalizer 102 to normalize the business-level user requirements into normalized user requirements 165 for storing in normalized user requirements database 103. Advantageously, by such normalization, the varied specifications of multiple cloud service providers 116 in the Cloud 180 may be easily and uniformly matched for choosing the cloud resources within a user cloud configuration needed to run a user application (not shown) at best price and performance.

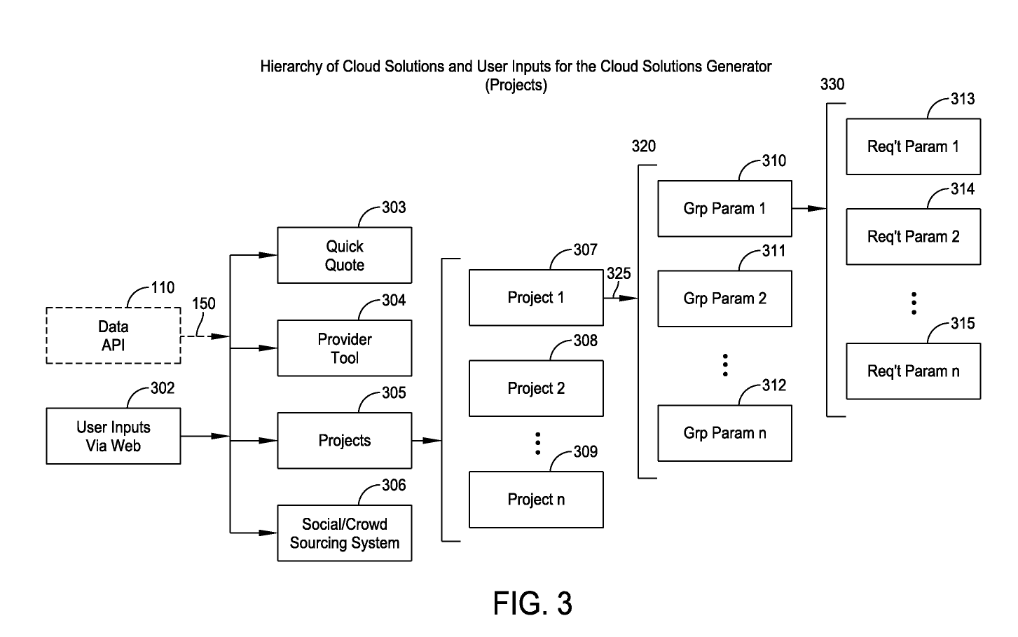

Continuing with FIG. 1, in various embodiments, business-level user requirements may allow the user to specify non-provisionable cloud resources as well as provisionable cloud resources such as for compute, storage, and memory functions, where non-provisionable cloud resources may be user requirements critical to the performance, availability, or consistency of the user application performance yet not directly selectable from service providers 116. For example, non-provisionable cloud resources may include a read/write latency of a storage device, a throughput density of a storage device, a start-up time of the user application, or a cloud up-time. Advantageously, user interface 101 may present the user with choices of non-provisionable cloud resources that are abstracted from provisionable cloud resources mapped from benchmarking data collected periodically from service providers 116 (discussed below). In this way, solutions generator 10 may provide for the selection of “real-world” business-level user requirements that allow the user to confidently select a service provider that meets all of the needs of a user application. In FIGS. 3-5, in various embodiments described later, additional details describe how the business-level user requirements may be hierarchically organized.

Back-end processor 120 may operate asynchronously from front-end processor 121 and may thereby partition the background tasks of collecting service provider data from the front-end tasks of calculating cloud solutions for a user application and interfacing with user 171. This partitioning may aggregate the computational intensity of mining service provider data for the benefit of all users who don't have to “reinvent the wheel” for each new user application, thereby reducing costs to the user and providing a quick solution for a user. Alternately, back-end processor 120 and front-end processor 121 may be synchronized for determining optimized solutions 104 spontaneously. For example, a sudden and drastic change in the services offering of a service provider may alert a client-user to request an immediate assessment of the user cloud configuration for a critical user application.

Continuing with FIG. 1, in an embodiment, the back end of solutions generator 10 may be operated by back-end processor 120 as indicated in FIG. 1 and may include a price discovery engine 114 interrogating multiple cloud service providers (“service providers”) 117, 118, and 119, receiving provider pricing 176 for various cloud services on a periodic or event-triggered basis. A services offering discovery engine 115 may interrogate multiple service providers 117, 118, and 119, and may receive parameters of services offerings 177 on a periodic or event-triggered basis. Proprietary provider pricing 176 and services offering 177 may be sent to metrics normalizer 111 where they are normalized into normalized provider metrics 170 for comparing multiple service providers 116 in a user-centric manner. Normalized provider metrics 170 may be stored in SP landscape database 112 and may describe at least one of the type, amount, price and quality of the cloud resources offered by service providers 116 and provisionable by user interface 101.

Referring still to FIG. 1, in various embodiments, performance benchmarking engine 200 may periodically characterize a performance of the services offering 178 from service providers 116 by running a suite of benchmarking test cases 202 each having a configuration of cloud resources. The characterized configurations may be designed to the provide performance data necessary to verify, correct, or abstract the performance of provisionable and non-provisionable cloud resources selectable by the user. In various embodiments, statistical analysis of cloud resources may be performed over time, such as for compute, storage, or memory resources, in order to assess the average or standard deviation (consistency) of performance. For example, the read IOPS (input output per second) per GB for a storage device may be specified by the service provider as having a maximum sustained value of 0.3 for typical instance types, but the user application may need a consistent average value of 0.2 and may depend on a particular instance type. In this case, performance benchmarking 500 may be used to abstract a performance result for a non-provisionable cloud resource selectable as a possible business-level user requirement.

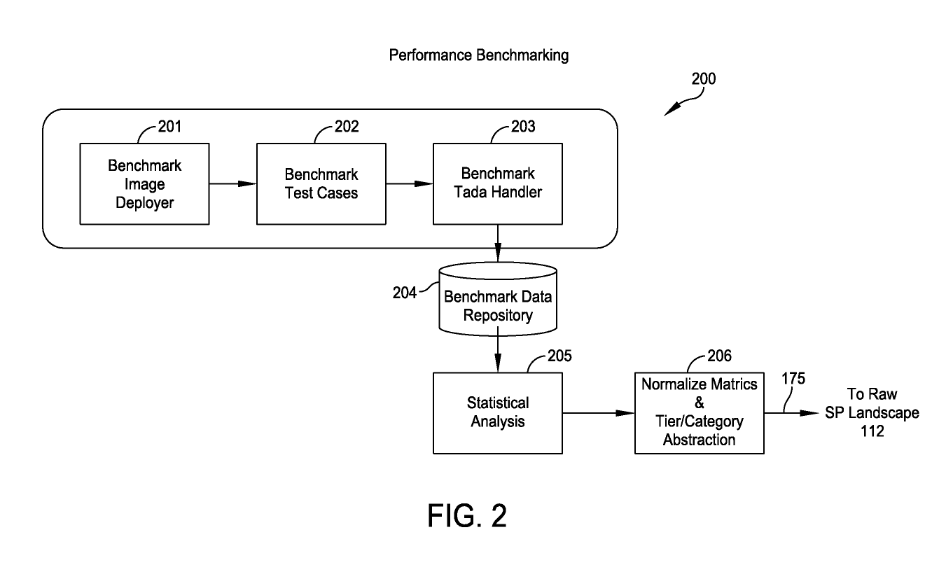

Referring to FIGS. 1 and 2, in various embodiment embodiments, benchmarking data 178 may be normalized into benchmarking metrics 175 and stored in the SP landscape database 112 and may be directly mappable to normalized user requirements 165 and normalized provider metrics 170. Benchmarking test cases may be run periodically, for example, on a daily or weekly basis. In this way, changes in the pricing or the cloud components and technologies deployed by the service providers 116 may be reflected into the design of a new user application or the maintenance of an existing user application.

Continuing with the flowchart in FIG. 2, in various embodiments, image deployer 201 may direct a number of test cases 202 to execute on one or more service provider platforms 116 based on a thorough list of cloud resources available across all service providers in the ecosystem of the solutions generator 10. Data handler 203 may prepare the collected benchmarking data 178 for storage in benchmarking data repository 204. Statistical analysis 205 may determine the consistency of the results as compared to similar past historical results. For example, the statistical analysis 205 may determine the consistency of the read/write response time of a hard drive by characterizing the mean and standard deviation of measurements taken over many benchmarking executions. In this instance, ‘response time’ may be an abstracted performance result of a non-provisionable resource mappable to an abstracted performance requirement available as a business-level user requirement.

Additionally, in an embodiment, normalization and categorization block 206 may assign a ‘consistency score’, based on the statistical analysis of benchmarking data over time, to a particular service provider for a resource such as ‘response time’, and the service provider may be categorized in a tier of performance. Normalization and categorization data 206 may then pass benchmarking metrics 175 to SP landscape database 112. In an embodiment, benchmarking metrics 175 may be categorized into a plurality of performance tiers for each service provider 116. For example, three performance tiers—Gold, Silver and Bronze—may be used to categorize the performance of the service provider. If, for example, the consistency of ‘response time’ in a storage device is high (low standard deviation) for service provider 117, then service provider 117 may be assigned to a Gold tier for storage. A similar process may be applied to compute resources, in terms of measuring CPU and RAM efficacy.

Continuing with FIGS. 1 and 2, in various embodiments, ‘protection’ may be another kind of cloud resource (besides compute, memory, storage) to which performance tiers may be applied. For example, a Gold tier may be used to categorize regional (e.g. outside of metro area) and local (metro/zone) protection, whereas the lower tier Silver may specify only local (metro/zone) protection, and Bronze may categorize ‘no protection’. On the front end of solutions generator 10, the user 171 may specify performance requirements in tiers to match the performance results categorized on the back, and may thereby achieve a better price-performance solution than if no tiering were applied. Performance tiers may be applied to service providers as a whole, to kinds of cloud resources such as compute, memory, storage, and protection, and/or to individual performance requirements.

Referring now to FIG. 1, in various embodiments, solutions calculator 113 may generate a number of potential user configurations with benchmarking performance 175 and provider pricing in order to assemble a finite solutions set 185 of the best price and performance solutions for each potential user configuration. A large number of solutions may be stored in finite solutions set database 109 for accommodating any potential user configuration that a user requests. For example, for a particular benchmarking test case, service provider 117 may provide the best performance and price, and for another benchmarking test case, service provider 118 may provide the best performance and price.

Continuing, in various embodiments, since benchmarked performance may not match the quoted performance and pricing, solutions calculator 113 may scale normalized provider metrics by the benchmarking metrics to calculate a potential configuration performance and price for each potential user configuration. Such scaling may effectively calculate a “handicap” factor for a service provider's offering such that the user will know how much of the offering they will need to buy to satisfy the user's requirement. This scaling is also crucial for accurate price comparison between service providers since one provider's offering rate may look good on the surface but end up costing more than another service provider's because more is required. For some cloud resources that are benchmarked, for instance, for abstracted performance results/requirements, there may be no provider pricing because the cloud resource is not provisionable. In the case of abstracted performance results, the solutions calculator 113 may import and associate the benchmarked performance with the provider pricing for the underlying provisionable cloud resources and with the potential user configuration. Solutions calculator 113 may then store a finite solution set 185 in finite solution set database 109 where at least one service provider may have the best potential configuration performance and price for each potential user configuration.

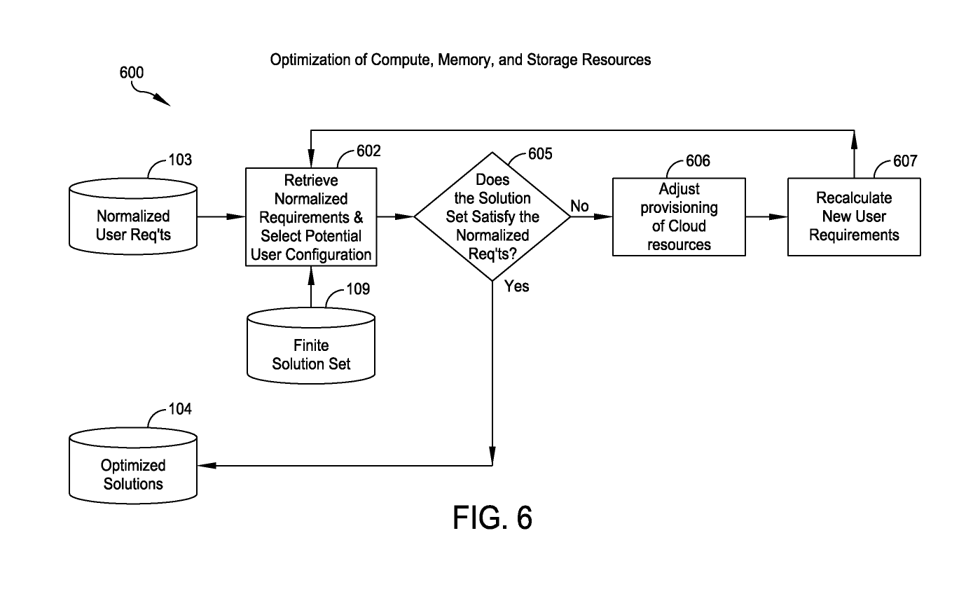

Referring now to FIGS. 1 and 6, in various embodiments, the optimizer 108 may receive normalized user requirements 165 from database 103 and may select 602 at least one potential user configuration from finite solution set 109 whose potential configuration performance satisfies the user application performance requirements. If satisfied (605), the optimizer 108 may store the selected at least one potential user configuration as an optimized solution 190 in optimized solutions database 104. If the user application performance is not satisfied (605) by any solutions in solution set 109, the optimizer 108 may optimize 606 the user cloud configuration by iteratively selecting cloud resources different from those originally selected in the business-level user requirements until at least one potential user configuration 607 satisfies the user application performance. Optimizer 108 may then store the optimized solution 190 in database 104 for routing to solutions summary 105. For example, if the optimizer identifies additional cloud resources to satisfy the technical requirements of the user application, the user may be notified in solution summary 105 that more resources will have to be purchased than originally expected.

Continuing with FIGS. 1 and 6, in an embodiment, optimizer 108 may include a compute and memory optimization loop 106 for optimizing compute and memory requirements of the user cloud configuration. Optimizer 108 may include a storage loop 107 for optimizing a storage requirement of the user cloud configuration. Optimized solutions for the storage and for the compute and memory loops may be stored in optimized solutions database 104. In an alternative embodiment, cloud resources of at least one potential user configuration stored in the finite solution set may distribute a solution across a plurality of service providers; in other words, a user application may deploy a portion of its cloud resources on one SP platform and another portion on another SP platform. In another embodiment, service provider updates 182 may be routed from SP landscape database 112 directly to optimizer 108 for re-optimizing a solution for a user who has already selected a solution and wants to periodically update the optimization.

Continuing with FIGS. 1 and 6, in various embodiments, if there is at least one abstracted performance requirement not provisionable by a service provider and included in the business-level user requirements, that abstracted performance requirement may be measured in benchmarking metrics as an abstracted performance result and may be matched to the complementary abstracted performance requirement specified in the business-level user requirements as part of the optimization process. Performance tiers based on abstracted performance requirements may be applied to the optimization process, where optimizer 108 optimizes a solution for each of multiple performance tiers for presenting solutions set to the user based on tiered performance and pricing. For example, normalized user requirements from database 103 may contain requirements for user application performance at a Gold, Silver, and Bronze level of performance, and tiered benchmarking data may deliver potential configuration performance at Gold, Silver, and Bronze levels, which is processed through solutions calculator 113 and stored in finite solution set database 109.

Referring now to FIGS. 3 through 5, in various embodiments, cloud solutions generator 10 (not shown) may exist within a larger hierarchy of cloud solutions and may be accessible through the projects 305 block. A user may approach this larger hierarchy of solutions through a web interface 302 or data API feed 110, and may access a provider tool 304 which may be a pricing calculator for estimating the cost of hosting a user application. Or, the user may access price and performance information from a crowd-sourcing system 306 comprising opinions, ratings, or data on the quality of services from users of various service providers. QuickQuote 303 may access a price and performance recommendation through solutions generator 10 based on abbreviated data.

Referring still to FIGS. 3 through 5, in various embodiments, a user of solutions generator 10 may create one or more projects (305, 306, 307) for hosting a user application with one or more service providers, and the solutions generator 10 may launch a Group 320 and Requirements 330 screen for entering business-level user requirements 325 which may comprise group-level parameters (310, 311, 312) and requirements-level parameters (313, 314, 315) within a group-level. Business-level user requirements 325 may including specifying a user cloud configuration for running a user application having a desired user application performance.

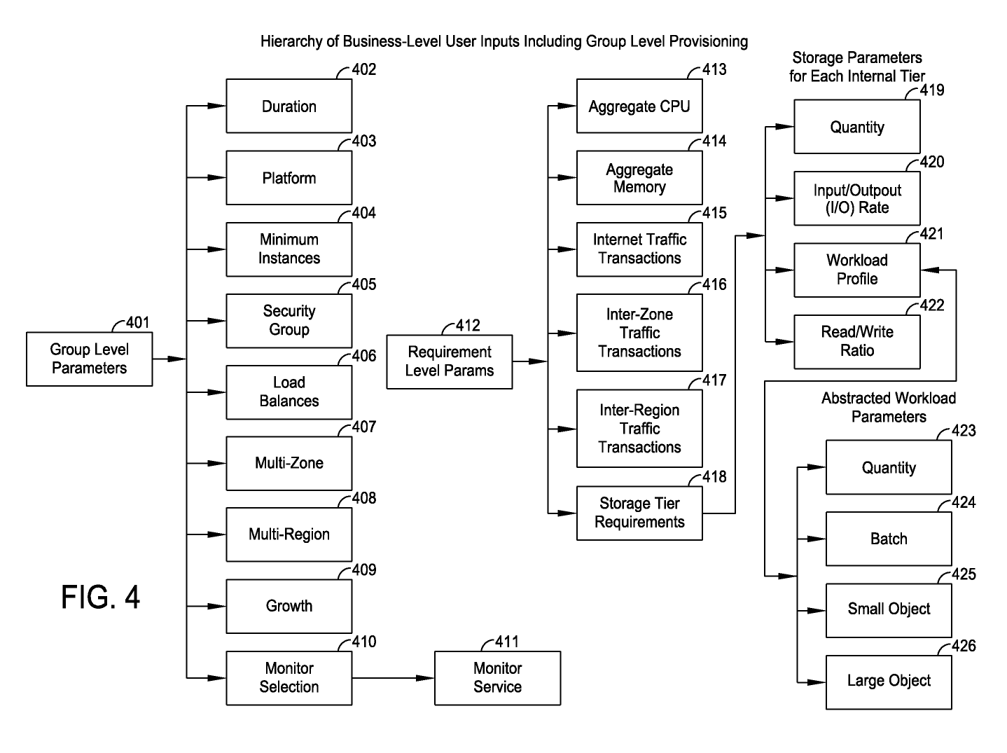

Referring to FIG. 4, in various embodiments, group level parameters 401 may comprise low-level computing provisioning at a service provider in the following categories:

(402) Duration—time in months that the user requires cloud resources;

(403) Platform—for example, the Infrastructure-as-a-Service (IaaS), operating system (e.g. Windows, Linux), Platform-as-a-Service (PaaS);

(404) Minimum instances—the minimum number of compute instances;

(405) Security group—for protecting all compute instances in this group;

(406) Load balancers—for balancing the incoming traffic load into the compute instances;

(407) Multi-zone—protection for compute instance at the metro level;

(408) Multi-region—protection for compute instance at the region level;

(409) Growth—growth pattern applied to all requirements in the group;

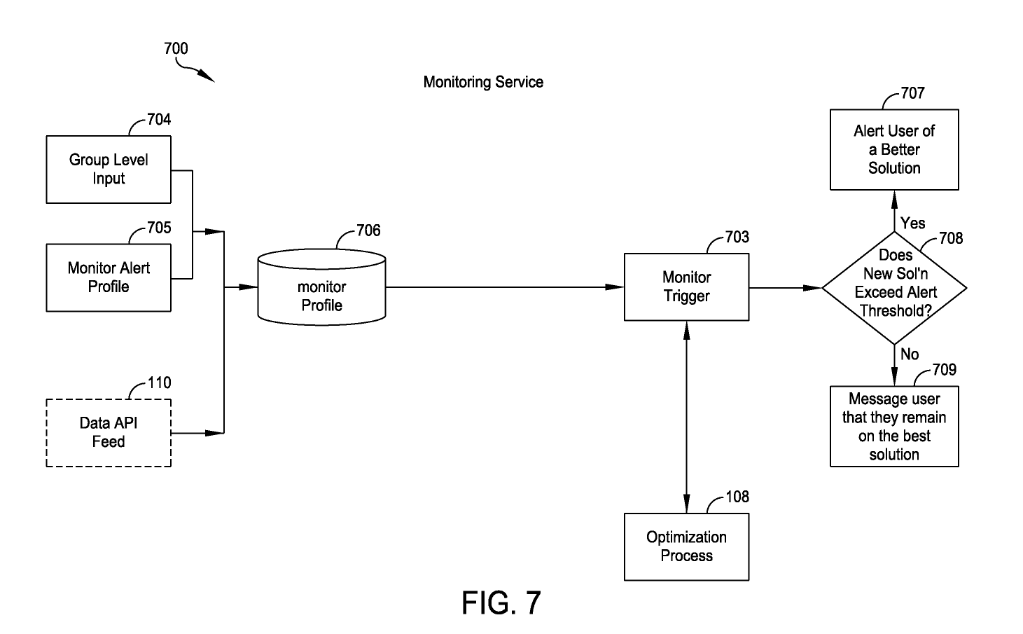

(410) Monitor selection—a cloud solutions maintenance service 411 (FIG. 7).

Referring to FIG. 4, in various embodiments, requirements-level parameters 412 may be designed to abstract the “real world” business/software application level needs from the lower-level computing infrastructure specification needed to satisfy those business needs. Advantageously, the normalization of user inputs and the abstraction of provisionable and non-provisionable cloud resources, including tiering, may be more user-friendly than a traditional price calculator that require the user to already know the computing infrastructure components of a service provider. Requirements level parameters may comprise the following computing and network traffic parameters (413-417):

(413) Aggregate CPU—the total amount of computing power needed;

(414) Aggregate Memory—the total amount of memory needed;

(415) Internet Traffic Transactions—the total number of application-level transactions that flow inbound to and outbound from this requirements module;

(416) Inter-zone Traffic Transactions—the total number of application-level transactions that flow between this requirements module and its paired local/metro availability zone;

(417) Inter-region Traffic Transactions—the total number of application-level transactions that flow between this requirements module and its paired regional availability zone.

In an embodiment, storage tier requirements parameters 218 may be included as a requirements level parameter for entering storage requirements that may be abstracted from provider offerings and benchmarking data or both. In an embodiment, the user may define these 4 parameters (419-422) for multiple performance tiers. For example, 3 service tiers may be available to the user:

(419) Quantity—the storage required in the service tiers (Gigabytes);

(420) Input/Output (I/O) Rate—total rate of data inbound from and outbound to the storage defined in (419), in I/O per second (IOPS);

(421) Workload Profile—a set of parameters that defines the business profile and size of the workload that exploits the storage in this service tier;

(422) Read/Write Ratio—the ratio between read operations (outbound from storage) and write operations (inbound to storage).

In an embodiment, performance tiers may have 3 tiers, and may be defined for storage accordingly:
GOLD—intended for business-critical software applications that require a high level of performance, availability and consistency;
SILVER—intended for business-tolerant software applications that require a moderate level of performance, availability and consistency;
BRONZE—intended for general purpose, highly-tolerant software applications that can tolerate a low level of performance, availability and consistency.

In an embodiment, referring to FIG. 4, the abstracted workloads that comprise workload profile 421 may be further broken down as follows:

(423) Transactional—maps to a small block I/O traffic profile in the block storage realm;

(424) Batch—maps to a large block I/O traffic profile in the block storage realm;

(425) Small Object—maps to a small I/O traffic profile in the object storage realm;

(426) Large Object—maps to a large I/O traffic profile in the object storage realm.

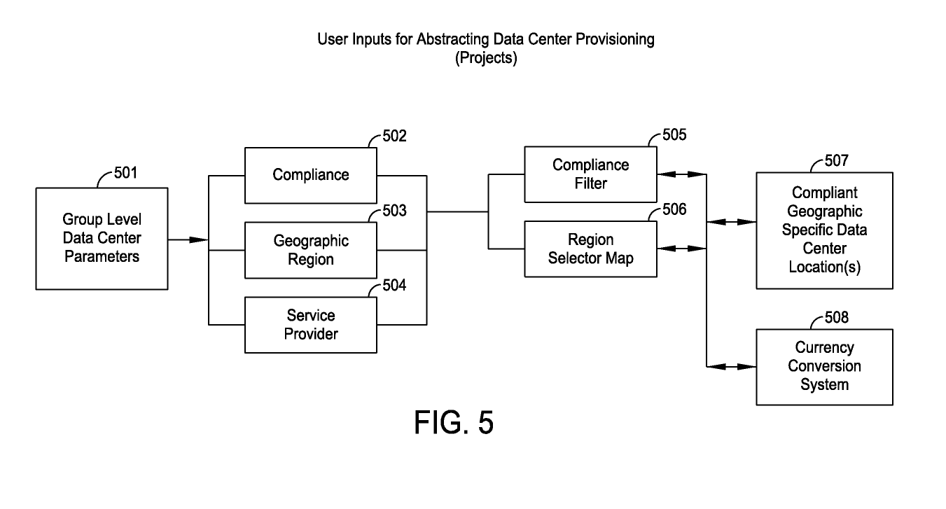

Referring now to FIG. 5, in an embodiment, business-level user requirements at the Group 320 (FIG. 3) level may break out further into a group level parameter 501 for abstracting data provisioning in the cloud. Three parameters set by the user may be correlated with each other to act as a filter that produces data center location 507 as a subset of security compliance 502 and geographic region 503 datacenter locations. Predetermined mapping may exist between the service providers 504 and which security compliance 502 it may offers and in which particular datacenter 503. Mapping may be maintained between global regions and service provider datacenters that exist within those regions. The cryptic service provider datacenter codes may be abstracted from the user by filtering through compliance filter 505 and region selector map 506. Region information originating from geographic region 503 and filtered through region selector map 506 is passed to the Currency Conversion System 508.

Referring now to FIGS. 1 and 7, in various embodiments, a monitor service 700 may be included in the solution generator 10 to ensure that the initial solution remains optimal for a user who has already launched a user application. Technology changes, price reductions, and performance degradations in the service provider platform may change the optimum solution for a user. The user may enable the monitor service 700 by entering a monitor alert profile 705 and group level inputs 704 at user interface 101 for storage in monitor profile 706. Group level inputs 704 may define which performance parameters to monitor and monitor alert profile 705 may define under what conditions action is to be taken (e.g. re-optimize the solution, notify the user). For example, a price change over a certain threshold may be detected in the normalized provider metrics 170. In another example, benchmarking metrics 175 may indicate a drop in storage, triggering optimization process 108. Also, a user's solution may be triggered on a periodic basis.

Monitor alert profile 705 and group level inputs 704 may also be entered via an API data feed 110. When monitor alert 715 triggers a re-evaluation of the optimized solution 190, monitor trigger 703 may begin the optimization process 108. Optimization 108 may proceed as before when a user is setting up a solution set for the first time. The optimization process 108 may select at least one potential user configuration from finite solution set 109 whose potential configuration performance satisfies the user application performance requirements. The potential configuration performance may be tested 708 against the application performance requirements to determine if the difference exceeds an alert threshold. The monitoring service may stay with the pre-alert optimized solution 709 if the answer is NO or advise the user of a better solution 707 if YES.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

Various embodiments of the present systems and methods may be used as a tool internally by a cloud consultant as input into a final report for a client.

Various embodiments of the present systems and methods may be integrated into upstream or downstream supply chain or provisioning systems in the form of OEM.

Various embodiments of the present systems and methods may be the foundation for a cloud marketplace resource trading or bidding system.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A cloud solutions generator for optimizing pricing and performance in a configuration of cloud resources, comprising:
a front-end processor having a user interface and a back-end processor running asynchronously from the front-end processor;
a provider pricing and a services offering both retrieved by the back-end processor from at least one service provider and normalized into a normalized provider metrics for comparing multiple service providers and for describing at least one of the type, amount, price and quality of the cloud resources;
one or more benchmarking test cases periodically characterizing a performance of the services offering of the at least one service provider, the back-end processor storing benchmarking metrics resulting from the executed one or more benchmarking test cases;
a user interface receiving, from a user, business-level user requirements for running a user application having a user application performance, the business-level user requirements including specifying a user cloud configuration of the cloud resources provisionable from the at least one service provider, the front-end processor normalizing the business-level user requirements into a normalized user requirements for mapping the normalized provider metrics to the business-level user requirements, and where the cloud resources comprise at least one of compute, storage, and memory resources;
a solutions calculator connecting to the back-end processor scales the normalized provider metrics by the benchmarking metrics to calculate a potential configuration performance for at least one potential user configuration of cloud resources specifiable in the business-level user requirements and provisionable by the at least one service provider, the solutions calculator storing a finite solution set for the at least one service provider, the finite solution set comprising the at least one service provider having the best potential configuration performance and price for the at least one potential user configuration; and
an optimizer receiving the normalized user requirements and selecting the at least one potential user configuration in the finite solution set whose potential configuration performance best matches the user application performance, the optimizer storing the selected at least one potential user configuration as an optimized solution for recommending to the user.

2. The cloud solutions generator of claim 1, wherein:
the optimizer optimizes the user cloud configuration if the user application performance is not satisfied by the selected at least one potential user configuration, the optimizing comprising iteratively selecting cloud resources different from those originally selected in the business-level user requirements until at least one potential user configuration satisfies the user application performance and storing the at least one potential user configuration as the optimized solution.

3. The cloud solutions generator of claim 2, further comprising:
the benchmarking metrics including at least one abstracted performance result not directly provisionable from the at least one service provider, the business-level user requirements including at least one abstracted performance requirement not directly provisionable from the at least one service provider, and the potential configuration performance including the at least one abstracted performance result for mapping to the at least one abstracted performance requirement.

4. The cloud solutions generator of claim 3, further comprising:
the at least one abstracted performance result being categorized into a plurality of performance tiers selectable in the business-level user requirements, where the plurality of performance tiers describe categories of one of performance, availability and consistency.

5. The cloud solutions generator of claim 4, wherein:
the plurality of performance tiers comprise categories of statistical performance and where the abstracted performance requirement comprises at least one of a read/write latency of a storage device, a throughput density of a storage device, a start-up time of the user application, a cloud up-time.

6. The cloud solutions generator of claim 2, wherein:
optimizing the cloud resources comprises adjusting the cloud resources according to at least one of scaling linearly, incrementing to the next available step in the service offerings, scaling by the benchmarking metrics.

7. The cloud solutions generator of claim 2, further comprising:
the optimizer having a compute and memory loop for optimizing compute and memory requirements of the user cloud configuration, and further comprising the optimizer having a storage loop for optimizing a storage requirement of the user cloud configuration.

8. The cloud solutions generator of claim 2, wherein:
the optimizer utilizes the benchmarking metrics for optimizing the cloud resources if the user application performance is not satisfied, where the optimizer iteratively selects cloud resources different from those originally selected and scales the normalized user requirements by the benchmarking metrics for generating the optimized solution.

9. The cloud solutions generator of claim 1, further comprising:
the benchmarking metrics including at least one abstracted performance result not directly provisionable from the at least one service provider, the business-level user requirements including at least one abstracted performance requirement not directly provisionable from the at least one service provider, and the potential configuration performance including the at least one abstracted performance result for mapping to the at least one abstracted performance requirement.

10. The cloud solutions generator of claim 9, further comprising:
the at least one abstracted performance result being categorized into a plurality of performance tiers selectable in the business-level user requirements, where the plurality of performance tiers describe categories of one of performance, availability and consistency.

11. The cloud solutions generator of claim 10, wherein:
the plurality of performance tiers comprise categories of statistical performance and where the abstracted performance requirement comprises at least one of a read/write latency of a storage device, a throughput density of a storage device, a start-up time of the user application, a cloud up-time.

12. The cloud solutions generator of claim 1, further comprising:
a monitor service selectable as a business-level user requirement, the monitor service responding to at least one of a service provider update and a periodic trigger, the responding being at least one of re-evaluating the optimized solution and notifying the user, where the service provider update indicates a possible change in the provider pricing or the performance of the services offering.

13. The cloud solutions generator of claim 1, wherein:
the cloud resources not directly provisionable comprise at least one of a consistency in a read/write latency of a storage device, a consistency in a throughput density of a storage device, an average start-up time of the user application, an amount of a cloud up-time.

14. The cloud solutions generator of claim 1, further comprising:
a data API (application programming interface) feed connected to the front-end processor for entering business-level user requirements.

15. The cloud solutions generator of claim 14, wherein:
the data API feed is configured to communicate with the monitor service.

16. A method for generating a cloud solution optimizing the pricing and performance in a configuration of cloud resources, comprising:
interfacing with a user via a user interface;
retrieving a provider pricing and a services offering from at least one cloud service provider;
normalizing the provider pricing and the services offering into a normalized provider metrics for directly comparing multiple cloud service providers, the normalized provider metrics describing at least one of the type, amount, price and quality of the cloud resources;
benchmarking the at least one cloud service provider for periodically characterizing a performance of the services offering;
storing a benchmarking metrics resulting from the executed one or more benchmarking test cases;
inputting business-level user requirements from the user interface for running a user application having a user application performance, the business-level user requirements specifying a user cloud configuration of the cloud resources directly provisionable from the at least one cloud service provider, where the cloud resources comprise at least one of compute, storage, and memory resources;
normalizing the business-level user requirements into normalized user requirements for mapping the normalized provider metrics to the business-level user requirements;
scaling the normalized provider metrics by the benchmarking metrics to calculate a potential configuration performance for at least one potential user configuration of cloud resources specifiable in the business-level user requirements and provisionable by the at least one service provider;
storing a finite solution set for the at least one service provider, the finite solution set comprising the at least one service provider having the best potential configuration performance and price for the at least one potential user configuration;
receiving by an optimizer the normalized user requirements and selecting the at least one potential user configuration in the finite solution set whose potential configuration performance best matches the user application performance; and
storing the selected at least one potential user configuration as an optimized solution for recommending to the user.

17. The method of claim 16, further comprising:
optimizing the user cloud configuration if the user application performance is not satisfied by the selected at least one potential user configuration, the optimizing comprising iteratively selecting cloud resources different from those originally selected in the business-level user requirements until at least one potential user configuration satisfies the user application performance; and
storing the at least one potential user configuration as the optimized solution.

18. The method of claim 17, further comprising:
abstracting from the benchmarking at least one abstracted performance result not directly provisionable from the at least one service provider;
including in the business-level user requirements at least one abstracted performance requirement not directly provisionable from the at least one cloud service provider; and
including in the potential configuration performance the at least one abstracted performance result for mapping to the at least one abstracted performance requirement.

19. The method of claim 18, further comprising:
categorizing the at least one abstracted performance result into a plurality of performance tiers selectable in the business-level user requirements, where the plurality of performance tiers describe categories of one of performance, availability and consistency.

20. The method of claim 19, wherein:
the plurality of performance tiers comprise categories of statistical performance and where the abstracted performance requirement comprises at least one of a read/write latency of a storage device, a throughput density (IOPS per GB) of a storage device, a start-up time of the user application, a cloud up-time.

21. The method of claim 16, further comprising:
monitoring the optimized solution by responding to at least one of a service provider update and a periodic trigger, the responding comprising at least one of re-evaluating the optimized solution and notifying the user, where the service provider update indicates a substantial change in the provider pricing or the performance of the services offering, the monitoring being selectable in the business-level user requirements.

22. The method of claim 16, further comprising:
entering business-level user requirements via an data API (application programming interface) feed connected to the front-end processor.

23. The method of claim 16, wherein:
the cloud resources of at least one potential user configuration stored in the finite solution set are distributed among a plurality of service providers.
